(19) United States
(12) Patent Application Publication
(10) Pub. No.: US 2026/0266199 A1
(43) Pub. Date: Sep. 10, 2026

(54) BEARING DAMPER ASSEMBLY FOR A TURBINE ENGINE

(71) Applicant: General Electric Company, Evendale, OH (US)

(72) Inventors: Bugra H. Ertas, Niskayuna, NY (US); Ravindra Shankar Ganiger, Bengaluru (IN)

(21) Appl. No.: 19/070,016

(22) Filed: Mar. 4, 2025

(51) Int. Cl. F01D 25/16

(52) U.S. Cl. CPC F01D 25/164; F05D 2240/50; F05D 2260/96

(57) ABSTRACT

A bearing damper assembly for a turbine engine includes a damper frame, an annular bearing housing disposed in the damper frame, and an end seal plate coupled to the bearing housing. The bearing housing includes an outer rim coupled to the damper frame, an inner rim coupled to the outer rim via a plurality of integral springs, a first plurality of annular gaps and a second plurality of annular gaps formed between the outer rim and the inner rim, and a first fluid circuit and a second fluid circuit in fluid communication with the first plurality of annular gaps and the second plurality of annular gaps, respectively. The first plurality of annular gaps and the second plurality of annular gaps are configured to be filled with fluid via the first fluid circuit and the second fluid circuit, respectively, to damp vibrations produced on a rotating component of the turbine engine.

### TECHNICAL FIELD

The present disclosure generally relates to bearing damper assemblies for turbine engines.

### BACKGROUND

Turbine engines, for example, for an aircraft, generally include a fan section and a turbo-engine to drive the fan section. Turbo-engines generally include a compressor section, a combustion section, and a turbine section in a serial flow arrangement. One or more bearing damper assemblies may reduce vibration of a rotating component of the turbo-engine.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic, cross-sectional diagram of a turbine engine, taken along a longitudinal centerline axis of the turbine engine, according to the present disclosure.

FIG. 2 is a schematic view of an exemplary bearing damper assembly of a turbine engine, according to the present disclosure.

FIG. 3 is a front, elevational view of a bearing damper assembly of a turbine engine, according to another embodiment of the present disclosure.

FIG. 4 is a rear, elevational view of the bearing damper assembly of FIG. 3.

FIG. 5 is an exploded view of the bearing damper assembly of FIG. 3.

FIG. 6 is a front, top perspective view of a bearing housing of the bearing damper assembly of FIG. 5.

FIG. 7 is a front, elevational view of the bearing housing of FIG. 6.

FIG. 8 is a side, elevational view of the bearing housing of FIG. 6.

FIG. 9 is an enlarged, detail view of the area labeled “9” in FIG. 7.

FIG. 10 is a front, elevational view of a bearing frame of the bearing damper assembly of FIG. 5.

FIG. 11 is a rear, elevational view of an end seal plate of the bearing damper assembly of FIG. 5.

FIG. 12 is a cross-sectional view taken along line 12-12 of FIG. 4.

FIG. 13 is an enlarged, detail view of the area labeled “13” in FIG. 12, with bolts removed.

FIG. 14 is a partial, cross-sectional view taken along line 14-14 of FIG. 4.

FIG. 15 is a partial, cross-sectional view taken along line 15-15 of FIG. 4.

FIG. 16A is a schematic view of the bearing damper assembly of FIGS. 2 to 15 operated in a first damping mode, according to the present disclosure.

FIG. 16B is a schematic view of the bearing damper assembly of FIGS. 2 to 15 operated in a second damping mode, according to the present disclosure.

FIG. 16C is a schematic view of the bearing damper assembly of FIGS. 2 to 15 operated in a third damping mode, according to the present disclosure.

FIG. 17 represents, in graph form, a damping level of the bearing damper assembly as operated in each of the modes of FIGS. 16A to 16C, according to the present disclosure.

FIG. 18 is a front, side perspective view of a bearing housing of a bearing damper assembly, according to another embodiment of the present disclosure.

FIG. 19 is a partial, cross-sectional view taken along line 19-19 of FIG. 18.

FIG. 20 is a partial, cross-sectional view of another bearing damper assembly, according to another embodiment of the present disclosure.

FIG. 21 is flowchart showing a method of damping vibrations of a rotating component of a turbine engine via a bearing damper assembly, such as the bearing damper assembly of FIGS. 2 to 15, according to the present disclosure.

### DETAILED DESCRIPTION

Features, advantages, and embodiments of the present disclosure are set forth or apparent from a consideration of the following detailed description, drawings, and claims.

Moreover, the following detailed description is exemplary and intended to provide further explanation without limiting the scope of the disclosure as claimed.

Various embodiments of the present disclosure are discussed in detail below.

While specific embodiments are discussed, this is done for illustration purposes only. A person skilled in the relevant art will recognize that other components and configurations may be used without departing from the present disclosure.

As used herein, the terms “first,” “second,” “third,” etc., may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or vehicle, and are based on a normal operational attitude of the turbine engine or vehicle. More particularly, forward and aft are used herein with reference to a direction of travel of the vehicle. More particularly, forward and aft are used herein with reference to a direction of travel of the vehicle and a direction of propulsive thrust of the turbine engine.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a longitudinal centerline axis of the turbine engine.

Moreover, the terms “radial” and “radially” refer to directions and orientations that extend substantially perpendicular to the longitudinal centerline axis of the turbine engine. In addition, as used herein, the terms “circumferential” and “circumferentially” refer to directions and orientations that extend arcuately about the longitudinal centerline axis of the turbine engine.

As used herein, the term “rotating component” refers to any component of a rotary machine, such as a turbine engine, that rotates about an axis of rotation. By way of example, a rotating component may include a shaft or a spool of a turbine engine, such as a fan shaft, a high-pressure shaft, a low-pressure shaft, etc. Likewise, the term “static component,” as used herein, refers to any stationary or non-rotating component of a turbine engine that has a coaxial configuration and arrangement with a rotating component of the turbine engine. A static component may be disposed radially inward or radially outward along a radial axis in relation to at least a portion of a rotating component. Additionally, or alternatively, a static component may be disposed axially adjacent to at least a portion of a rotating component.

As used herein, the term “static structure” refers to any structural part of a rotary machine, such as a turbine engine, that is non-rotating.

As used herein, “redline speed” means the maximum expected rotational speed of a shaft or a rotor during normal operation of a turbine engine. The redline speed may be expressed in terms of rotations per second in Hertz (Hz), rotations per minute (RPM), or as a linear velocity of the outer diameter of the shaft in terms of feet per second. For a turbine engine that has a high speed shaft and a low speed shaft, both the high speed shaft and the low speed shaft have redline speeds.

As used herein, “critical speed” means a rotational speed of a shaft or a rotor of a turbine engine that is about the same as a fundamental, or a natural frequency, of a first-order bending mode of the shaft (e.g., the shaft rotates at eighty Hz and the first-order modal frequency is eighty Hz). When the shaft rotates at the critical speed, the shaft is expected to have a maximum amount of deflection, hence, instability, due to excitation of the first-order bending mode of the shaft. The critical speed may be expressed in terms of rotations per second in Hz, RPM, or as a linear velocity of the outer diameter of the shaft in terms of feet per second.

The term “supercritical speed,” as used herein, refers to a rotational speed of a shaft or a rotor of a turbine engine that is above a fundamental, or a natural frequency of a first-order bending mode of the shaft (e.g., the shaft rotates at eighty Hz while the first-order modal frequency is about seventy Hz). A “supercritical shaft” is a shaft that has a redline speed above the critical speed of the shaft.

As used herein, the term “additive manufacturing technology” or “additive manufacturing techniques or processes” generally refer to manufacturing processes wherein successive layers of material(s) are provided on each other to “build-up,” layer-by-layer, a three-dimensional component. The successive layers generally fuse together to form a monolithic component that may have a variety of integral sub-components. Although additive manufacturing technology is described herein as enabling fabrication of complex objects by building objects point-by-point, layer-by-layer, typically, in a vertical direction, other methods of fabrication are possible and within the scope of the present subject matter. For example, although the discussion herein refers to the addition of material to form successive layers, one skilled in the art will appreciate that the methods and the structures disclosed herein may be practiced with any additive manufacturing technique or manufacturing technology. For example, embodiments of the present disclosure may use layer-additive processes, layer-subtractive processes, or hybrid processes.

Approximating language, as used herein throughout the specification and claims, is applied to modify any quantitative representation that could permissibly vary without resulting in a change in the basic function to which it is related. Accordingly, a value modified by a term or terms, such as “about” and “substantially” is not to be limited to the precise value specified.

In at least some instances, the approximating language may correspond to the precision of an instrument for measuring the value, or the precision of the methods, or the machines for constructing the components, and/or the systems or manufacturing the components and/or the systems. For example, the approximating language may refer to being within a one, two, four, ten, fifteen, or twenty percent margin in either individual values, range(s) of values and/or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

Generally, a turbine engine (e.g., a turbofan engine) may facilitate transfer of energy between a fluid and a rotating component (e.g., a rotor). For example, a compressor of a turbofan engine may utilize the rotating component to transfer energy to the fluid by compressing the fluid. Further, a turbine engine may also use the rotating component to extract energy from a flow of the fluid. To facilitate the transfer of energy, a tangential force may actuate (e.g., rotate) the rotating component. However, the rotating component may exert an axial force and a radial force on the rest of the turbine engine. For example, rotation of the rotating component may cause mass imbalance and, thus, vibrations (e.g., radial forces) in the turbine engine. Additionally, due to gravity, the rotating component may exert a radial (e.g., downward) force. Furthermore, when the turbine engine is in operation, the rotating component may exert an axial (e.g., thrust) force.

To help account for these various forces exerted by the rotating component, the turbine engine may include one or more bearing damper assemblies. For example, a bearing damper assembly may dissipate vibrations (e.g., dynamic radial forces) produced on the rotating component, thereby reducing the vibrations transferred to the rest of the turbine engine.

Additionally, a bearing damper assembly may support the rotating component against other radial forces and axial forces to facilitate actuation of the rotating component. However, in some instances, tuning a bearing damper assembly to account for the other radial forces and axial forces may affect the ability of the bearing damper to dissipate vibrations.

One solution, for example, is a bearing damper assembly that may include a damper, e.g., a segmented squeeze film damper, which can include multiple annular gaps and bearings coupled between the damper and the rotating component. As such, a force exerted on the rotating component may be transferred to the damper through the bearings. For example, vibrations produced on the rotating component may propagate from the rotating component, through the bearings, and into the damper, where such vibrations may be dissipated by fluid in the one or more annular gaps thereof.

However, some turbine engines may require rotating components thereof (e.g., a low-pressure shaft or a high-pressure shaft) to have the ability to operate at super-critical speeds. Operation at supercritical speeds brings several challenges in rotor dynamics, including high speed stability and synchronous response to rotor imbalance. Furthermore, super-critical rotors require traversing through several rotor modes before achieving red line operating speeds. Thus, there is an optimum damping requirement for each mode and operating speed. For example, overly large damping force coefficients can lead to lowered stability margins and high dynamics bearing loads, and sufficiently low damping values can have the same effect. In other words, each operating mode requires an optimum damping value. However, traditional squeeze film dampers are typically designed for a single damping target value and do not have the capability to vary damping values as needed.

Accordingly, the present disclosure provides an improved bearing damper assembly for a turbine engine that has variable damping modes that can be used for various operating modes of the turbine engine. Particularly, embodiments of the present disclosure can provide a bearing damper assembly with a first plurality of damping sectors and a second plurality of damping sectors that can be activated independent of one another to provide various damping values of the bearing damper assembly. This can increase operational performance and durability of the bearing damper assembly and the turbine engine over a range of operating speeds.

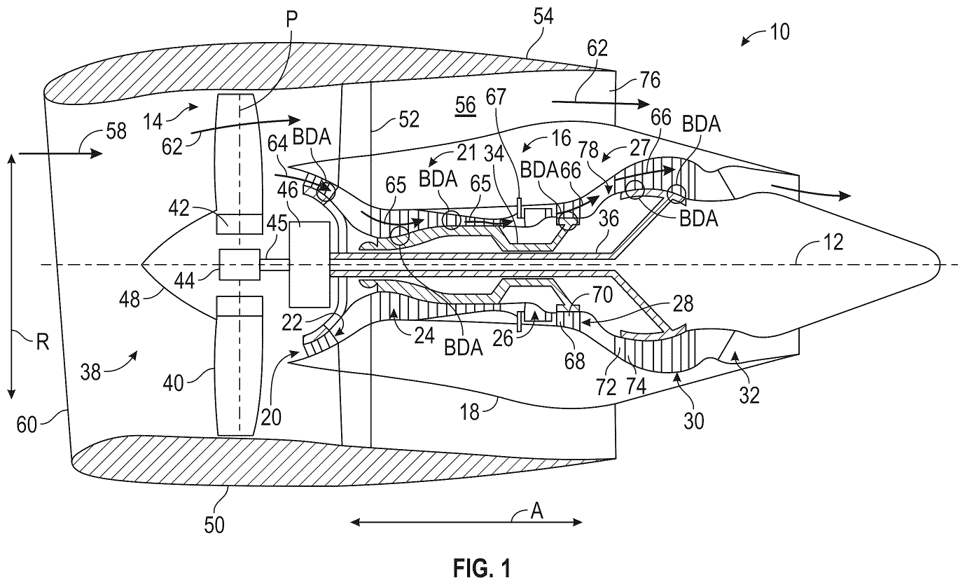

Referring now to the drawings, FIG. 1 is a schematic, cross-sectional diagram of a turbine engine 10, taken along a longitudinal centerline axis 12 of the turbine engine 10, according to an embodiment of the present disclosure. As shown in FIG. 1, the turbine engine 10 defines an axial direction A (extending parallel to the longitudinal centerline axis 12 provided for reference) and a radial direction R that is normal to the axial direction A. In general, the turbine engine 10 includes a fan section 14 and a turbo-engine 16 disposed downstream from the fan section 14.

The turbo-engine 16 includes, in serial flow relationship, a compressor section 21, a combustion section 26, and a turbine section 27. The turbo-engine 16 is substantially enclosed within an outer casing 18 that is substantially tubular and defines a core inlet 20 that is annular about the longitudinal centerline axis 12. As schematically shown in FIG. 1, the compressor section 21 includes a booster or a low-pressure (LP) compressor 22 followed downstream by a high-pressure (HP) compressor 24. The combustion section 26 is downstream of the compressor section 21. The turbine section 27 is downstream of the combustion section 26 and includes a high-pressure (HP) turbine 28 followed downstream by a low-pressure (LP) turbine 30. The turbo-engine 16 further includes a jet exhaust nozzle section 32 that is downstream of the turbine section 27, a high-pressure (HP) shaft 34 or a spool, and a low-pressure (LP) shaft 36. The HP shaft 34 drivingly connects the HP turbine 28 to the HP compressor 24. The HP turbine 28 and the HP compressor 24 rotate in unison through the HP shaft 34. The LP shaft 36 drivingly connects the LP turbine 30 to the LP compressor 22. The LP turbine 30 and the LP compressor 22 rotate in unison through the LP shaft 36. The compressor section 21, the combustion section 26, the turbine section 27, and the jet exhaust nozzle section 32 together define a core air flow path.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. In the case of a variable pitch fan, the plurality of fan blades 40 is rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline axis 12 via a fan shaft 45 that is powered by the LP shaft 36 across a power gearbox, also referred to as a gearbox assembly 46. In this way, the fan 38 is drivingly coupled to, and powered by, the turbo-engine 16, and the turbine engine 10 is an indirect drive engine. The gearbox assembly 46 is shown schematically in FIG. 1. The gearbox assembly 46 is a reduction gearbox assembly for adjusting the rotational speed of the fan shaft 45 and, thus, the fan 38 relative to the LP shaft 36 when power is transferred from the LP shaft 36 to the fan shaft 45.

Referring still to the exemplary embodiment of FIG. 1, the disk 42 is covered by a fan hub 48 that is aerodynamically contoured to promote an airflow through the plurality of the fan blades 40. In addition, the fan section 14 includes an annular fan casing or a nacelle 50 that circumferentially surrounds the fan 38 and at least a portion of the turbo-engine 16. The nacelle 50 is supported relative to the turbo-engine 16 by a plurality of outlet guide vanes 52 that are circumferentially spaced about the nacelle 50 and the turbo-engine 16. Moreover, a downstream section 54 of the nacelle 50 extends over an outer portion of the turbo-engine 16, and, with the outer casing 18, defines a bypass airflow passage 56 therebetween.

During operation of the turbine engine 10, a volume of air 58 enters the turbine engine 10 through an inlet 60 of the nacelle 50 or the fan section 14. As the volume of air 58 passes across the fan blades 40, a first portion of air, also referred to as bypass air 62, is routed into the bypass airflow passage 56, and a second portion of air, also referred to as core air 64, is routed into the upstream section of the core air flow path through the core inlet 20 of the LP compressor 22. The ratio between the bypass air 62 and the core air 64 is commonly known as a bypass ratio. The pressure of the core air 64 is then increased, generating compressed air 65.

The compressed air 65 is routed through the HP compressor 24 and into the combustion section 26, where the compressed air 65 is mixed with fuel 67 and ignited to generate combustion gases 66.

The combustion gases 66 are routed into the HP turbine 28 and expanded through the HP turbine 28 where a portion of thermal energy or kinetic energy from the combustion gases 66 is extracted via one or more stages of HP turbine stator vanes 68 and HP turbine rotor blades 70 that are coupled to the HP shaft 34. This causes the HP shaft 34 to rotate, thereby supporting operation of the HP compressor 24 (e.g., a self-sustaining cycle). In this way, the combustion gases 66 do work on the HP turbine 28. The combustion gases 66 are then routed into the LP turbine 30 and expanded through the LP turbine 30. Here, a second portion of the thermal energy or the kinetic energy is extracted from the combustion gases 66 via one or more stages of LP turbine stator vanes 72 and LP turbine rotor blades 74 that are coupled to the LP shaft 36.

This causes the LP shaft 36 to rotate, thereby supporting operation of the LP compressor 22 (e.g., a self-sustaining cycle) and rotation of the fan 38 via the gearbox assembly 46. In this way, the combustion gases 66 do work on the LP turbine 30.

The combustion gases 66 are subsequently routed through the jet exhaust nozzle section 32 of the turbo-engine 16 to provide propulsive thrust. Simultaneously, the bypass air 62 is routed through the bypass airflow passage 56 before being exhausted from a fan nozzle exhaust section 76 of the turbine engine 10, also providing propulsive thrust. The HP turbine 28, the LP turbine 30, and the jet exhaust nozzle section 32 at least partially define a hot gas path 78 for routing the combustion gases 66 through the turbo-engine 16.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. The turbine engine 10 may also be a direct drive engine, which does not have a power gearbox. The fan speed is the same as the LP shaft speed for a direct drive engine. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, turbojet engines, turboprop engines, or turboshaft engines.

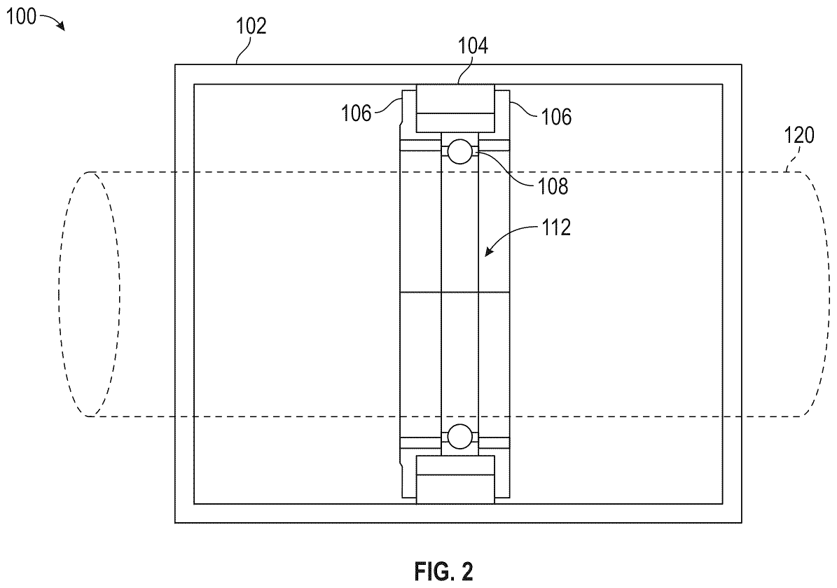

FIG. 2 is a schematic view of an exemplary bearing damper assembly 100 for the turbine engine 10 (FIG. 1), taken along the longitudinal centerline axis 12 (FIG. 1) of the turbine engine 10, according to the present disclosure. The bearing damper assembly 100 can be utilized to engage and to support a rotating component 120 of the turbine engine 10. The bearing damper assembly 100, however, can be used to support any rotating component of the turbine engine 10, or between any rotating component of other turbine engines. Particularly, the rotating component 120 may be any rotating component of the turbo-engine 16 (e.g., the LP shaft 36 or the HP shaft 34) of the turbine engine 10 (FIG. 1). By way of example, circles (BDA) of FIG. 1 provide example locations that the bearing damper assembly 100 of the present disclosure may be incorporated into the turbine engine 10. In some embodiments, the turbine engine 10 may include one or more bearing damper assemblies 100 at various suitable locations as indicated by circles BDA.

As shown in FIG. 2, the bearing damper assembly 100 includes a damper frame 102, a bearing housing 104, end seals 106, and bearings 108. In the illustrated embodiment, an outer surface (e.g., an outer rim) of the bearing housing 104 is coupled to an inner surface of the damper frame 102. In some embodiments, the bearing housing 104 may be fixedly coupled to the damper frame 102 (e.g., via screws, nuts, or other suitable fastening mechanisms). In such embodiments, movement of the outer rim of the bearing housing 104 relative to the damper frame 102 may be limited.

The bearings 108 are coupled to an inner surface of the bearing housing 104 and define an annular region 112, which may support the rotating component 120. As described above, the bearings 108 may facilitate rotation of the rotating component 120, for example, by reducing friction that resists rotation. In the illustrated embodiment, the bearings 108 are ball bearings. In some embodiments, the bearings 108 may be, e.g., journal bearings (i.e., porous bearing pads that deliver gas into the annular region 112). The bearings 108 are coupled between the bearing housing 104 and the rotating component 120. As such, the rotating component 120 may exert a force through the bearings 108 onto the bearing housing 104. For example, gravity may pull downward on the rotating component 120, thereby causing the rotating component 120 to exert a radial force on the bearing housing 104. Additionally, thrust from movement of the turbine engine 10 may cause the rotating component 120 to exert an axial force on the bearing housing 104.

Furthermore, during operation of the turbine engine 10, vibrations may be produced on the rotating component 120 (e.g., due to mass imbalance) that may propagate into the bearing housing 104. In some instances, vibrations of the rotating component 120 may affect operation of the turbine engine 10, for example, by disturbing or displacing other components.

As such, the bearing housing 104 may be used to damp (e.g., dissipate) vibrations of the rotating component 120, thereby reducing likelihood of vibrations affecting operation of the turbine engine 10.

Various types of dampers may be utilized in the bearing damper assembly 100 to damp vibrations of the rotating component 120. For example, in the illustrated embodiment, the bearing housing 104 of the bearing damper assembly 100 is a squeeze film damper that utilizes fluid in one or more annular gaps formed between an inner diameter and an outer diameter of the bearing housing 104. In this way, damping characteristics (e.g., targeted frequencies or a targeted damping value) of the bearing housing 104 may be dependent at least in part on a pressure of the fluid in the one or more annular gaps. To facilitate control of pressure of the fluid, as depicted, the end seals 106 are coupled on both side surfaces of the bearing housing 104.

In some embodiments, the fluid pressure in the bearing housing 104 may be actively controlled (e.g., in real-time during operation of the turbine engine 10) by pumping fluid from the damper frame 102, through the one or more annular gaps, and out through the end seals 106. In other embodiments, the one or more annular gaps may be hermetically sealed and, thus, fluid pressure may be passively controlled (e.g., off-line before deployment of the bearing housing 104). Additionally, in some embodiments, a squeeze film damper (e.g., a segmented squeeze film damper) may include multiple annular gaps between its inner diameter and its outer diameter, which may facilitate improving damping performance. For example, compared to a “two pi” squeeze film damper, a segmented squeeze film damper may have a higher damping value, which may reduce the likelihood of conditions that affect the damping characteristics, such as cavitation and air ingestion.

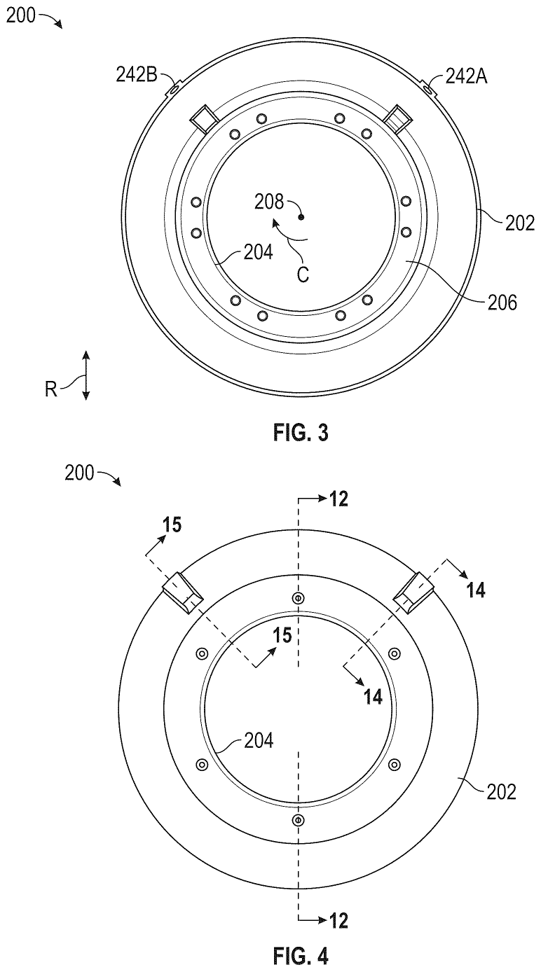

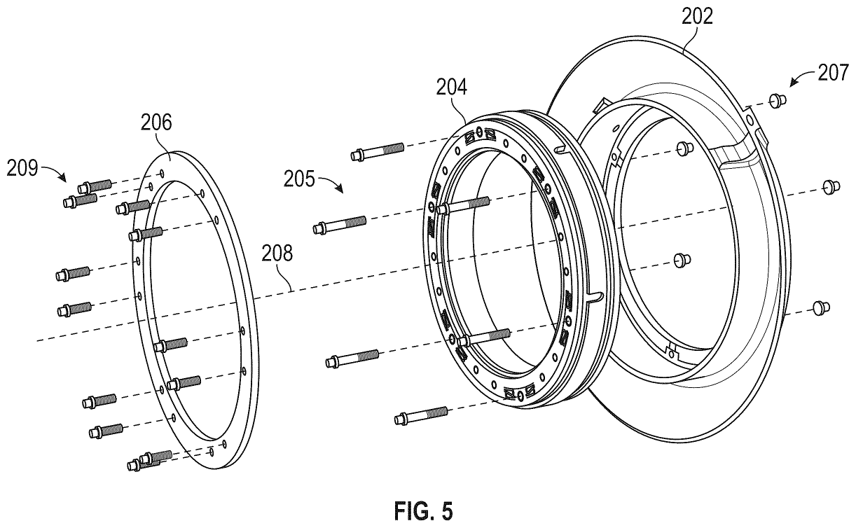

FIGS. 3 to 5 illustrate another exemplary bearing damper assembly 200, e.g., the bearing damper assembly of FIG. 2, of the turbine engine 10 (FIG. 1), according to another embodiment. FIG. 3 is a front, elevational view of bearing damper assembly 200. FIG. 4 is a rear, elevational view of the bearing damper assembly 200. FIG. 5 is an exploded view of the bearing damper assembly 200. The bearing damper assembly 200 is substantially similar to the bearing damper assembly 100 of FIG. 2. The same reference numerals or similar reference numerals will be used for components of the bearing damper assembly 200 that are the same as, or similar to, the components of the bearing damper assembly 100 discussed above with regard to FIG. 2. The description of such components above of the bearing damper assembly 100 also applies to these components of the bearing damper assembly 200, and a detailed description of these components is omitted here.

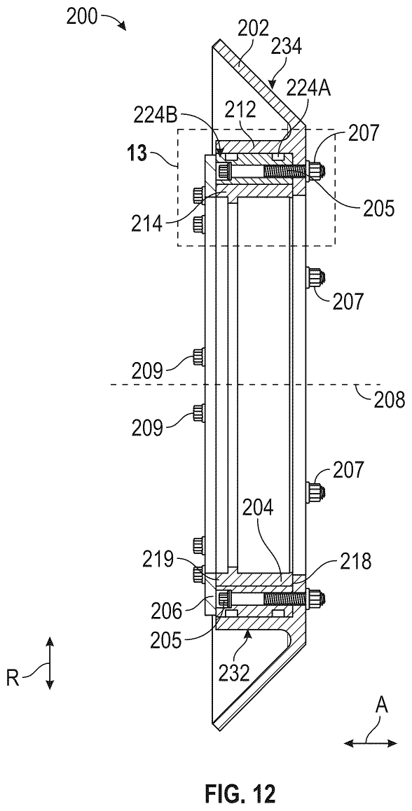

As shown in FIGS. 3 to 5, the bearing damper assembly 200 includes a damper frame 202, a bearing housing 204 disposed in (e.g., coupled to) the damper frame 202, and an end seal plate 206 coupled to the bearing housing 204. In the illustrated embodiment, the damper frame 202, the bearing housing 204, and the end seal plate 206 are annular such that bearing damper assembly 200 defines a bearing damper centerline axis 208 (FIG. 3). An axial direction A (FIG. 12) extends parallel to the bearing damper centerline axis 208, a radial direction R (FIG. 3) extends perpendicular to the bearing damper centerline axis 208, and a circumferential direction C (FIG. 3) extends about the bearing damper centerline axis 208. In some embodiments, one or more of the damper frame 202, the bearing housing 204, or the end seal plate 206 may not be annular.

As shown in FIG. 5, the bearing housing 204 is coupled to the damper frame 202 (e.g., via a plurality of housing fasteners 205 and a plurality of frame nuts 207), and the end seal plate 206 is coupled to the bearing housing (e.g., via a plurality of seal plate fasteners 209). The damper frame 202 may be coupled to a static component or a static structure (e.g., a frame) of the turbine engine 10.

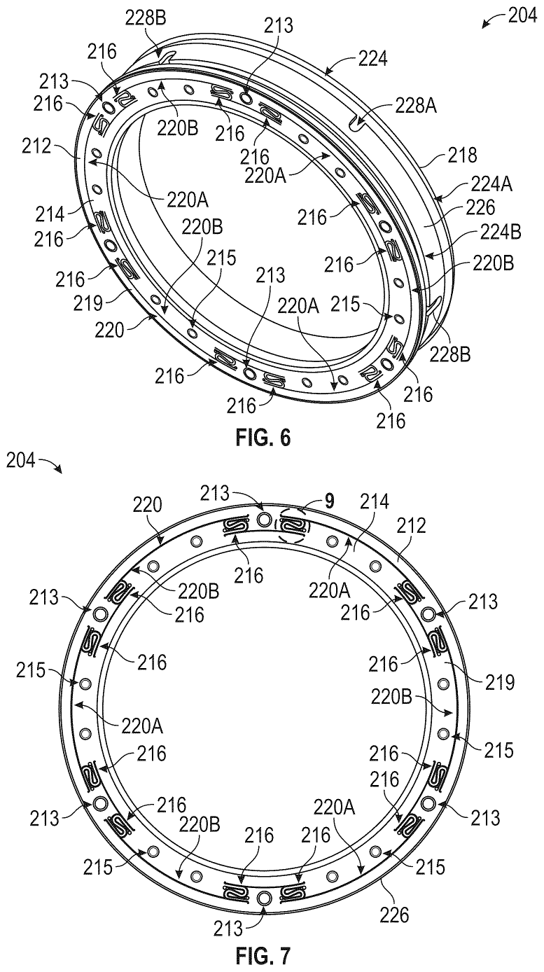

FIGS. 6 to 8 show the bearing housing 204 of the bearing damper assembly 200 (FIG. 5) in greater detail. FIG. 6 is a front, top perspective view of the bearing housing 204.

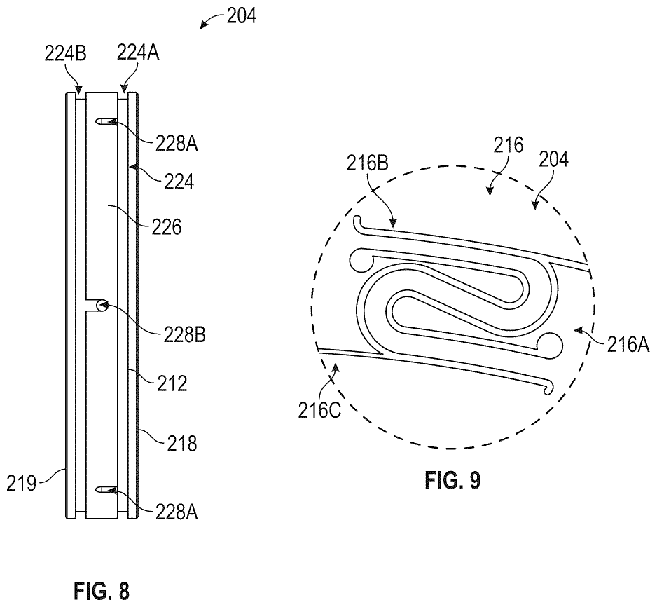

FIG. 7 is a front, elevational view of the bearing housing 204. FIG. 8 is a side, elevational view of the bearing housing 204. As shown in FIGS. 6 to 8, the bearing housing 204 has an outer rim 212, an inner rim 214 coupled to the outer rim 212 via a plurality of integral springs 216, a first side or an inner side 218, and a second side or an outer side 219 opposite the inner side 218. The outer rim 212 is coupled to the damper frame 202 (FIG. 5) (e.g., via the plurality of housing fasteners 205 (FIG. 5) received in a first plurality of housing openings 213 extending through the outer rim 212 and coupled to the plurality of frame nuts 207). As discussed in greater detail below, the plurality of integral springs 216 extends through the inner side 218 and the outer side 219 of the bearing housing 204. The inner rim 214 may receive bearings (e.g., bearings 108 of the bearing damper assembly 100 of FIG. 2).

As mentioned above, the end seal plate 206 (FIG. 5) is coupled to the bearing housing 204. More specifically, in the illustrated embodiment, the end seal plate 206 is coupled to the inner rim 214 of the bearing housing 204 (e.g., via the plurality of seal plate fasteners 209 (FIG. 5) received in a second plurality of housing opening 215 extending into the inner rim 214). In some embodiments, the end seal plate 206 may be coupled to the outer rim 212 of the bearing housing 204 or to the damper frame 202.

As shown best in FIG. 7, the bearing housing 204 has a plurality of annular gaps 220 formed between the outer rim 212 and the inner rim 214 that extends through the inner side 218 to the outer side 219. In particular, each annular gap of the plurality of annular gaps 220 is bound in the circumferential direction C by two integral springs of the plurality of integral springs 216. In other words, one integral spring of the plurality of integral springs 216 is disposed on either circumferential end of each annular gap 220.

The plurality of annular gaps 220 includes a first plurality of annular gaps 220A and a second plurality of annular gaps 220B. In the illustrated embodiment, the first plurality of annular gaps 220A and the second plurality of annular gaps 220B are arranged in an alternating manner in the circumferential direction C. Further, the plurality of integral springs 216 includes twelve integral springs and the plurality of annular gaps 220 include six annular gaps, with the first plurality of annular gaps 220A including three annular gaps and the second plurality of annular gaps 220B including three annular gaps.

However, the number and the arrangement of the plurality of integral springs 216 and the plurality of annular gaps 220 of the bearing housing 204 is not limited to any particular number or arrangement, and the number and the arrangement can be selected based on a desired damping effect to be provided to a rotating component (e.g., the rotating component 120 of FIG. 2). For example, in some embodiments, the first plurality of annular gaps 220A may include at least two annular gaps, the second plurality of annular gaps 220B may include at least two annular gaps, and the plurality of integral springs 216 may include at least eight integral springs. In some embodiments, the first plurality of annular gaps 220A may include at least four annular gaps, the second plurality of annular gaps 220B may include at least four annular gaps, and the plurality of integral springs 216 may include at least twelve integral springs. In some embodiments, the first plurality of annular gaps 220A and the second plurality of annular gaps 220B may be arranged in an alternating manner in the circumferential direction C. In some embodiments, the first plurality of annular gaps 220A may include a total number of annular gaps that differs from that of the second plurality of annular gaps 220B.

FIG. 9 is an enlarged, detail view of the area labeled “9” in FIG. 7. As shown in FIG. 9, each integral spring of the plurality of integral springs 216 includes a spring portion 216A, an active damper portion 216B, and a deflection limiter portion 216C. The spring portion 216A of the integral spring 216 is compressible in the radial direction such that at least portions of the inner rim 214 of the bearing housing 204 may move or orbit relative to the stationary outer rim 212 of the bearing housing 204 (FIG. 7) and to the damper frame 202 (FIGS. 3 to 5). The active damper portion 216B of the integral spring 216 is connected to the respective one of the plurality of annular gaps 220 (FIG. 7). The deflection limiter portion 216C of the integral spring 216 is connected to that of an adjacent integral spring of the plurality of integral springs 216. In this way, the deflection limiter portions 216C of the plurality of integral springs 216 may limit deflection of the inner rim 214 relative to the outer rim 212 of the bearing housing 204.

Referring again to FIGS. 6 to 8, in the illustrated embodiment, the plurality of integral springs 216 is integrally formed with the outer rim 212 and the inner rim 214 of the bearing housing 204 such that the bearing housing 204 is a monolithic, single piece. In some embodiments, the plurality of integral springs 216 may be formed via a subtractive manufacturing process, such as, e.g., a wire electrical discharge machining process. In some embodiments, the bearing housing 204 may be formed via one or more additive manufacturing processes.

By utilizing the plurality of annular gaps 220 of the bearing housing 204, particularly, the first plurality of annular gaps 220A and the second plurality of annular gaps 220B, the bearing damper assembly 200 may increase viscous resistance, thereby reducing a likelihood of circumferential flow, which may enable an increased radial gap (e.g., size) of the plurality of annular gaps 220. In this manner, the amount of fluid in an annular gap of the plurality of annular gaps 220 may be increased, which may facilitate an increased damping value of the bearing damper assembly 200 and may reduce a likelihood of conditions (e.g., cavitation and air ingestion in the plurality of annular gaps 220) that affect the damping value of the bearing damper assembly 200. As described above, the damping characteristics of the bearing housing 204 may also be affected by fluid pressure within the plurality of annular gaps 220. In some embodiments, the fluid pressure may be actively controlled by controlling flow of fluid through the plurality of annular gaps 220, or, more specifically, through the first plurality of annular gaps 220A and the second plurality of annular gaps 220B.

As best shown in FIGS. 6 and 8, the bearing housing 204 further includes a plurality of annular grooves 224 defined along an outer surface 226 of the outer rim 212. In the illustrated embodiment, the plurality of annular grooves 224 includes a first annular groove 224A disposed axially toward the inner side 218 and a second annular groove 224B disposed axially toward the outer side 219. The first annular groove 224A is in fluid communication with a first plurality of gap inlets 228A that extend into each of the annular gaps of the first plurality of annular gaps 220A. Likewise, the second annular groove 224B is in fluid communication with a second plurality of gap inlets 228B that extend into each of the annular gaps of the second plurality of annular gaps 220B. In other words, in the illustrated embodiment, the first plurality of gap inlets 228A includes three gap inlets that are in fluid communication with the respective three annular gaps of the first plurality of annular gaps 220A, and the second plurality of gap inlets 228B includes three gap inlets that are in fluid communication with the respective three annular gaps of the second plurality of annular gaps 220B.

In this way, fluid provided to the first annular groove 224A flows to each of the first plurality of annular gaps 220A via the first plurality of gap inlets 228A, and fluid provided to the second annular groove 224B flows to each of the second plurality of annular gaps 220B via the second plurality of gap inlets 228B. Thus, the first annular groove 224A at least partly defines a first fluid circuit of the bearing damper assembly 200, and the second annular groove 224B at least partly defines a second fluid circuit of the bearing damper assembly 200. In the illustrated embodiment, the first annular groove 224A is fluidly isolated from the second annular groove 224B, such that the first fluid circuit is fluidly isolated from the second fluid circuit.

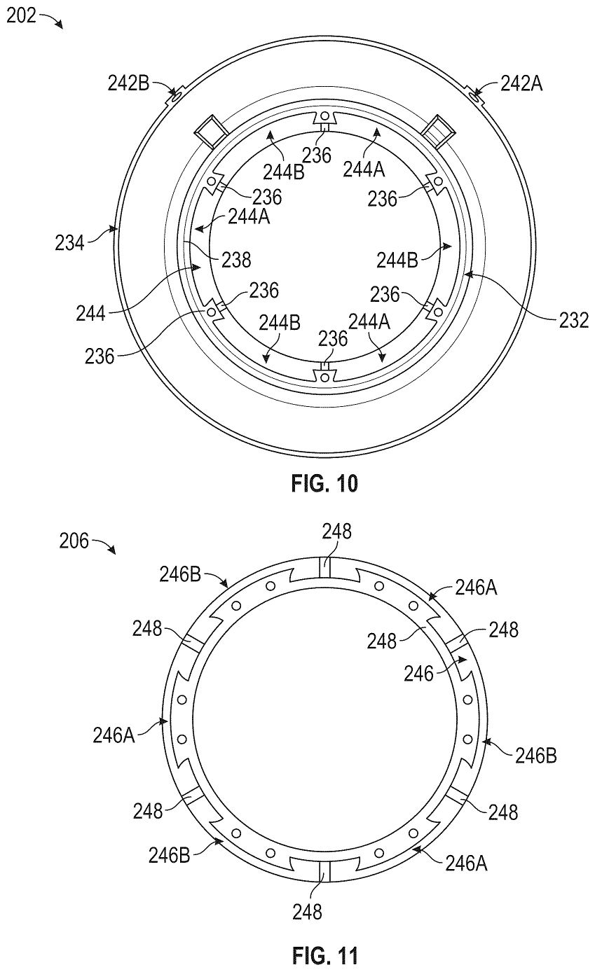

FIG. 10 is a front, elevational view of the damper frame 202 of the bearing damper assembly 200 of FIG. 5. As shown in FIG. 10, the damper frame 202 includes a flange portion 232 that receives the bearing housing 204 (FIG. 4) and a conical portion 234 extending radially outward from the flange portion 232. In the illustrated embodiment, the flange portion 232 has a first seal face 236 that extends radially outward relative to the bearing damper centerline axis 208 (FIG. 3) and a second seal face 238 that extends substantially perpendicular from the first seal face 236 (i.e., substantially parallel to the bearing damper centerline axis 208). The damper frame 202 further includes a first inlet port 242A and a second inlet port 242B extending from the conical portion 234 to the second seal face 238 of the flange portion 232. In some embodiments, the damper frame 202 can include two or more first inlet ports 242A and two or more second inlet ports 242B. As will be discussed in greater detail below, the damper frame 202 further includes a plurality of frame recesses 244 defined along the first seal face 236. More specifically, the plurality of frame recesses 244 includes a first plurality of frame recesses 244A and a second plurality of frame recesses 244B that are separated from each other by respective portions of the first seal face 236. In the illustrated embodiment, the plurality of frame recesses 244 includes six frame recesses corresponding to the six annular gaps of the plurality of annular gaps 220 (FIG. 7), with the first plurality of frame recesses 244A and the second plurality of frame recesses 244B each including three frame recesses.

FIG. 11 is a rear, elevational view of the end seal plate 206 of the bearing damper assembly 200 of FIG. 5. As shown in FIG. 11, the end seal plate 206 includes a plurality of seal plate recesses 246 defined along a plate seal face 248 of the end seal plate 206. In particular, the plurality of seal plate recesses 246 includes a first plurality of seal plate recesses 246A and a second plurality of seal plate recesses 246B that are separated from each other by respective portions of the plate seal face 248. In the illustrated embodiment, the plurality of seal plate recesses 246 includes six seal plate recesses that correspond to the six annular gaps of the plurality of annular gaps 220 (FIG. 7), with the first plurality of seal plate recesses 246A and the second plurality of seal plate recesses 246B each including three seal plate recesses.

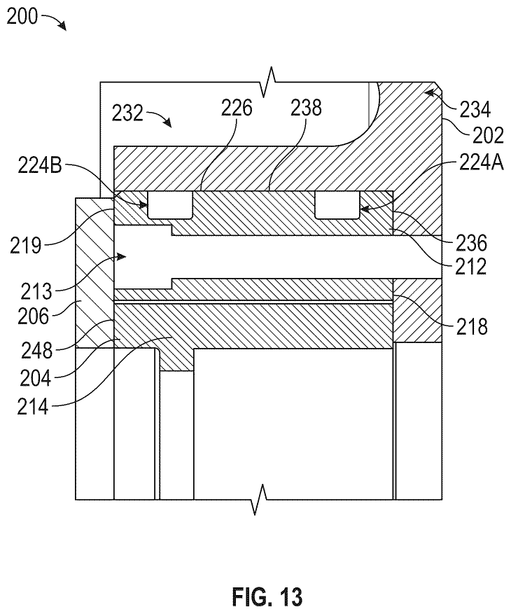

FIG. 12 is a cross-sectional view of the bearing damper assembly 200 taken along line 12-12 of FIG. 4. FIG. 13 is an enlarged, detail view of the area labeled “13” in FIG. 12, with the housing fasteners 205 (FIG. 12) and the frame nuts 207 (FIG. 12) of the bearing damper assembly 200 removed. As shown in FIG. 12, the bearing housing 204 is received within flange portion 232 of the damper frame 202 such that inner side 218 of the bearing housing 204 abuts the first seal face 236 of the damper frame 202 and the outer surface 226 of the outer rim 212 of the bearing housing 204 abuts the second seal face 238 of the damper frame 202. The end seal plate 206 is coupled to the outer side 219 of the bearing housing 204 such that the outer side 219 of the bearing housing 204 abuts the plate seal face 248 of the end seal plate 206. Further, the bearing housing 204 is arranged relative to the damper frame 202 such that each of the plurality of frame recesses 244 (FIG. 10) is aligned circumferentially with a respective annular gap of the plurality of annular gaps 220 (FIG. 7). Further, the end seal plate 206 is arranged relative to the bearing housing 204 such that each of the plurality of seal plate recesses 246 (FIG. 11) is aligned circumferentially with a respective annular gap of the plurality of annular gaps 220 and opposite a respective frame recess of the plurality of frame recesses 244 of the damper frame 202.

As shown in FIG. 13, the outer surface 226 of the outer rim 212 of the bearing housing 204 abuts the second seal face 238 of the flange portion 232 of the damper frame 202 such that a first circumferential seal is formed between the first annular groove 224A and the outer surface 226, and a second circumferential seal is formed between the second annular groove 224B and the outer surface 226. Further, the inner side 218 of the bearing housing 204 abuts the first seal face 236 of the flange portion 232 of the damper frame 202, while the outer side 219 of the bearing housing 204 abuts the plate seal face 248 of the end seal plate 206. In this way, radial seals are formed between each of the plurality of annular gaps 220 (FIG. 7) via the first seal face 236 and the plate seal face 248 such that each of the first plurality of annular gaps 220A (FIG. 7) is fluidly isolated from each of the second plurality of annular gaps 220B (FIG. 7).

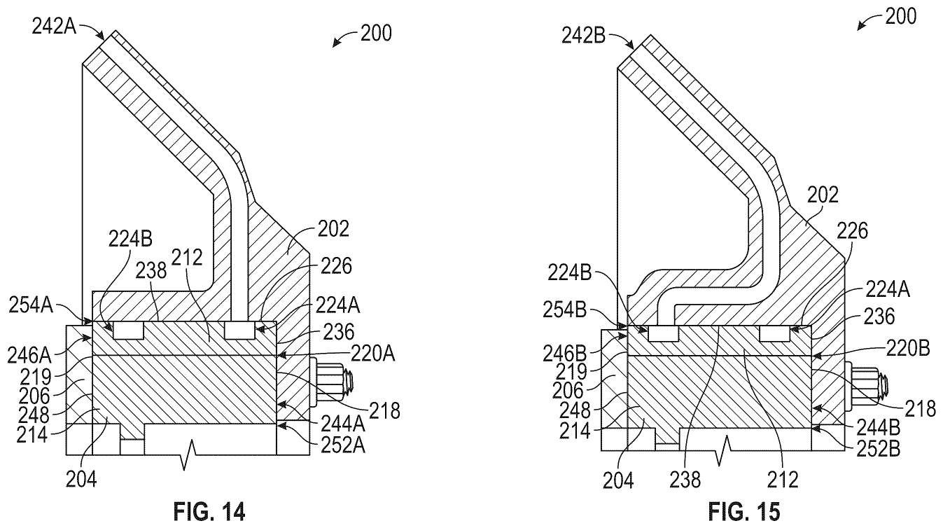

FIG. 14 is a partial, cross-sectional view of the bearing damper assembly 200 taken along line 14-14 of FIG. 4. As shown in FIG. 14, the first inlet port 242A of the damper frame 202 extends to the first annular groove 224A of the bearing housing 204 such that the first inlet port 242A is in fluid communication with the first plurality of annular gaps 220A of the bearing housing 204 via the first annular groove 224. More specifically, fluid provided to the first inlet port 242A flows to the first annular groove 224A and to each of the first plurality of annular gaps 220A via the first plurality of gap inlets 228A (FIGS. 6 and 8).

Further, as previously mentioned, each of the first plurality of frame recesses 244A of the damper frame 202 and each of the first plurality of seal plate recesses 246A of the end seal plate 206 is aligned with a respective annular gap of the first plurality of annular gaps 220A. In this way, a first plurality of first outlets 252A of the first plurality of annular gaps 220A is defined by the first plurality of frame recesses 244A of the damper frame 202 and a first plurality of second outlets 254A of the first plurality of annular gaps 220A is defined by the first plurality of seal plate recesses 246A of the end seal plate 206. In other words, the first plurality of first outlets 252A is provided by a first clearance between the first plurality of frame recesses 244A and the inner side 218 of the bearing housing 204, and the first plurality of second outlets 254A is provided by a second clearance between the first plurality of seal plate recesses 246A and the outer side 219 of the bearing housing 204. In this way, fluid provided to the first plurality of annular gaps 220A via the first annular groove 224A may flow out of the first plurality of annular gaps 220A via the first plurality of first outlets 252A and the first plurality of second outlets 254A.

FIG. 15 is a partial, cross-sectional view taken along line 15-15 of FIG. 4. As shown in FIG. 15, the second inlet port 242B of the damper frame 202 extends to the second annular groove 224B of the bearing housing 204 such that the second inlet port 242B is in fluid communication with the second plurality of annular gaps 220B of the bearing housing 204 via the second annular groove 224B. More specifically, fluid provided to the second inlet port 242B flows to the second annular groove 224B and to each of the second plurality of annular gaps 220B via the second plurality of gap inlets 228B (FIGS. 6 and 8).

Further, each of the second plurality of frame recesses 244B of the damper frame 202 and each of the second plurality of seal plate recesses 246B of the end seal plate 206 is aligned with a respective annular gap of the second plurality of annular gaps 220B. In this way, a second plurality of first outlets 252B of the second plurality of annular gaps 220B is defined by the second plurality of frame recesses 244B of the damper frame 202 and a second plurality of second outlets 254B of the second plurality of annular gaps 220B is defined by the second plurality of seal plate recesses 246B of the end seal plate 206. In other words, the second plurality of first outlets 252B is provided by a first clearance between the second plurality of frame recesses 244B and the inner side 218 of the bearing housing 204, and the second plurality of second outlets 254B is provided by a second clearance between the second plurality of seal plate recesses 246B and the outer side 219 of the bearing housing 204. In this way, fluid provided to the second plurality of annular gaps 220B via the second annular groove 224B may flow out of the second plurality of annular gaps 220B via the second plurality of first outlets 252B and the second plurality of second outlets 254B.

Thus, in some embodiments, as illustrated in FIGS. 14 and 15, a damping value provided by the first plurality of annular gaps 220A (FIG. 14) may differ from that of the second plurality of annular gaps 220B (FIG. 15). Particularly, a flow rate (e.g., as provided by clearances between respective defining surfaces) of one or both of the first plurality of first outlets 252A or the first plurality of second outlets 254A of the first plurality of annular gaps 220A (FIG. 14) may be varied relative to that of one or both of the second plurality of first outlets 252B or the second plurality of second outlets 254B of the second plurality of annular gaps 220B (FIG. 15). In this way, the varied flow rates of one or both of the first plurality of first outlets 252A or the first plurality of second outlets 254A (FIG. 14) relative to that of one or both of the second plurality of first outlets 252B or the second plurality of second outlets 254B (FIG. 15) may vary the damping value provided by the first plurality of annular gaps 220A (FIG. 14) relative to the damping value provided by the second plurality of annular gaps 220B (FIG. 15).

In the illustrated embodiment, the bearing damper assembly 200 is configured such that the first plurality of annular gaps 220A (FIG. 14) provide a damping value that is different (e.g., greater) than that of the second plurality of annular gaps 220B (FIG. 15). Particularly, a depth of the first plurality of seal plate recesses 246A (FIG. 14) (e.g., as measured in the axial direction A (FIG. 12) between the surface of the first plurality of seal plate recesses 246A and the outer side 219 of the bearing housing 204) is different (e.g., less) than that of the second plurality of seal plate recesses 246B (FIG. 15) such that a flow rate of the first plurality of second outlets 254A (FIG. 14) is different (e.g., less) than that of the second plurality of second outlets 254B (FIG. 15). In some embodiments, a depth of the first plurality of frame recesses 244A (FIG. 14) (e.g., as measured in the axial direction A (FIG. 12) between the surface of the first plurality of frame recesses 244A and the inner side 218 of the bearing housing 204) may be different than that of the second plurality of frame recesses 244B (FIG. 15) such that a flow rate of the first plurality of first outlets 252A (FIG. 14) may be different than that of the second plurality of first outlets 252B (FIG. 15). In some embodiments, the bearing damper assembly 200 may be configured such that the first plurality of annular gaps 220A provides a damping value that is substantially the same as that of the second plurality of annular gaps 220B.

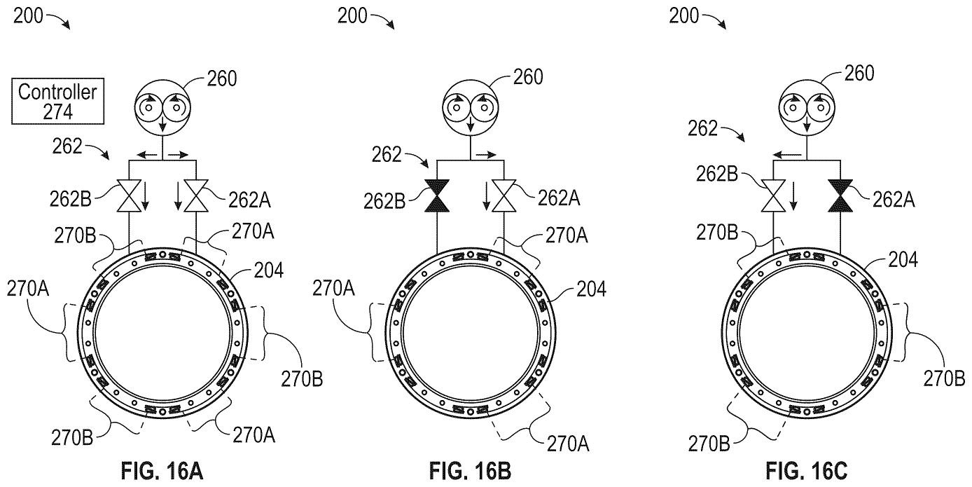

FIGS. 16A to 16C are schematic views of the bearing damper assembly 200. For ease of illustration, the damper frame 202 (FIG. 5) and the end seal plate 206 (FIG. 5) of the bearing damper assembly 200 are not shown. As shown in FIG. 16A, in some embodiments, the bearing damper assembly 200 can include a pump 260 that can provide fluid to the first fluid circuit (i.e., into the first inlet port 242A to the first annular groove 224A and to the first plurality of annular gaps 220A via the first plurality of gap inlets 228A) and the second fluid circuit (i.e., into the second inlet port 242B to the second annular groove 224B and to the second plurality of annular gaps 220B via the second plurality of gap inlets 228B). One or more valves 262 can be disposed between the pump 260 and the bearing damper assembly 200 to selectively provide fluid to one or both of the first fluid circuit or the second fluid circuit of the bearing damper assembly 200 via the first inlet port 242A and the second inlet port 242B, respectively.

In the illustrated embodiment, the one or more valves 262 includes a first valve 262A disposed between the pump 260 and the first inlet port 242A and a second valve 262B disposed between the pump 260 and the second inlet port 242B. In this way, the bearing damper assembly 200 can be operated in one of three modes-a first damping mode (FIG. 16A), a second damping mode (FIG. 16B), and a third damping mode (FIG. 16C)—via control of the first valve 262A and the second valve 262B. In the illustrated embodiment, the pump 260 is a gear pump and the first valve 262A and the second valve 262B are two-way ball valves. In some embodiments, the pump 260 may be a centrifugal pump, a positive displacement pump, a screw pump, etc., and each of the first valve 262A and the second valve 262B may be a solenoid actuated ball valve.

As shown in FIG. 16A, the bearing damper assembly 200 can be operated in the first damping mode by operating the pump 260 with each of the first valve 262A and the second valve 262B in open positions, such that fluid from the pump 260 is supplied to each of the first plurality of annular gaps 220A and the second plurality of annular gaps 220B of the bearing housing 204. With the bearing damper assembly 200 operated in the first damping mode, both a first plurality of circumferential damping sectors 270A corresponding to the first plurality of annular gaps 220A and a second plurality of circumferential damping sectors 270B corresponding to the second plurality of annular gaps 220B are activated (i.e., providing active damping). Thus, while operating in the first damping mode, the bearing damper assembly 200 can provide a first damping level.

As shown in FIG. 16B, the bearing damper assembly 200 can be operated in the second damping mode by operating the pump 260 with the first valve 262A in the open position and the second valve 262B in a closed position, such that fluid from the pump 260 is supplied only to the first plurality of annular gaps 220A of the bearing housing 204. With the bearing damper assembly 200 operated in the second damping mode, the first plurality of circumferential damping sectors 270A is activated, while the second plurality of circumferential damping sectors 270B is deactivated (i.e., not providing active damping). Thus, while operating in the second damping mode, the bearing damper assembly 200 can provide a second damping level that is different than the first damping level.

As shown in FIG. 16C, the bearing damper assembly 200 can be operated in the third damping mode by operating the pump 260 with the first valve 262A in a closed position and the second valve 262B in the open position, such that fluid from the pump 260 is supplied only to the second plurality of annular gaps 220B of the bearing housing 204. With the bearing damper assembly 200 operated in the third damping mode, the first plurality of circumferential damping sectors 270A is deactivated while the second plurality of circumferential damping sectors 270B is activated. Thus, while operating in the third damping mode, the bearing damper assembly 200 can provide a third damping level that is different from the first damping level and the second damping level.

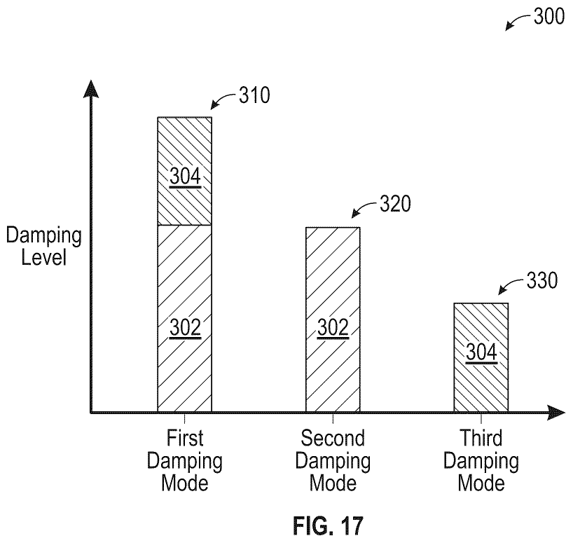

FIG. 17 represents, in graph form, a damping level of the bearing damper assembly 200 as operated in the first damping mode of FIG. 16A, the second damping mode of FIG. 16B, and the third damping mode of FIG. 16C. As previously mentioned, the bearing damper assembly 200 is configured such that the first plurality of annular gaps 220A of the bearing housing 204 provides a greater damping level than the second plurality of annular gaps 220B of the bearing housing. Thus, when activated, the first plurality of circumferential damping sectors 270A of the bearing damper assembly 200 provides a first damping level 302 that is greater than a second damping level 304 provided by the second plurality of circumferential damping sectors 270B of the bearing damper assembly 200.

As such, with the bearing damper assembly 200 operating in the first damping mode (FIG. 16A), as represented by bar 310 of graph 300 of FIG. 17, the first damping level provided by the bearing damper assembly 200 is a sum of the first damping level 302 and the second damping level 304. Further, with the bearing damper assembly 200 operating in the second damping mode (FIG. 16B), as represented by bar 320 of graph 300 of FIG. 17, the second damping level provided by the bearing damper assembly 200 is only the first damping level 302. Finally, with the bearing damper assembly 200 operating in the third damping mode (FIG. 16C), as represented by bar 330 of graph 300 of FIG. 17, the third damping level provided by the bearing damper assembly 200 is only the second damping level 304.

Referring again to FIGS. 16A to 16C, in some embodiments, the bearing damper assembly 200 can include an electronic controller 274 (FIG. 16A) that can be in electrical communication with the first valve 262A and the second valve 262B. In some such embodiments, the electronic controller 274 can be configured to selectively operate the bearing damper assembly 200 (e.g., via control of the first valve 262A and the second valve 262B) in the first damping mode (FIG. 16A), the second damping mode (FIG. 16B), or the third damping mode (FIG. 16C). For example, in some such embodiments, the electronic controller 274 can be configured, in response to a first operating condition (e.g., a first sensed speed of the rotating component 120 (FIG. 2)) of the turbine engine 10 (FIG. 1), to operate the bearing damper assembly 200 in the first damping mode, and, in response to a second operating condition (e.g., a second sensed speed of the rotating component 120 that is less than first speed) of the turbine engine 10, operate the bearing damper assembly 200 in the second damping mode. Further, the electronic controller 274 can be further configured, in response to a third operating condition (e.g., a third sensed speed of the rotating component 120 that is less than the second speed) of the turbine engine 10 (FIG. 1), to operate the bearing damper assembly 200 in the third damping mode. In some embodiments, an electronic controller (not shown) of the turbine engine 10 (FIG. 1) may be in electrical communication with the first valve 262A and the second valve 262B of the bearing damper assembly 200 and with one or more other bearing damper assemblies of the turbine engine 10.

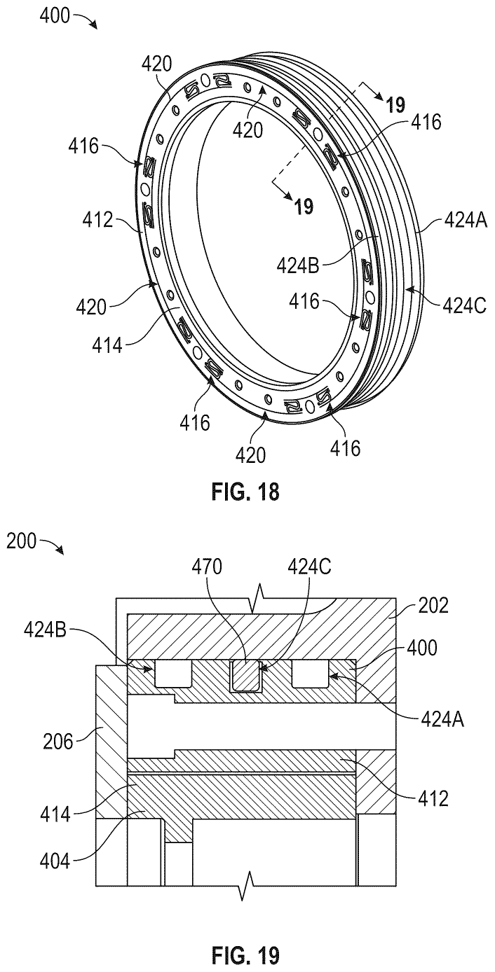

FIG. 18 is a front, side perspective view of a bearing housing 404 of a bearing damper assembly, e.g., the bearing damper assembly 200 of FIGS. 2 to 15, according to another embodiment of the present disclosure. The bearing housing 404 is substantially similar to the bearing housing 204 of FIGS. 6 to 9. The same reference numerals or similar reference numerals will be used for components of the bearing housing 404 that are the same as, or similar to, the components of the bearing housing 204 discussed above with regard to FIGS. 2 to 15. The description of such components above of the bearing housing 204 also applies to these components of the bearing housing 404, and a detailed description of these components is omitted here.

As shown in FIG. 18, the bearing housing 404 includes an outer rim 412, an inner rim 414 coupled to the outer rim via a plurality of integral springs 416, and a plurality of annular gaps 420 similar to the outer rim 212, the inner rim 214, the plurality of integral springs 216, and the plurality of annular gaps 220 of the bearing housing 204 of FIGS. 6 to 9. Further, the bearing housing 404 includes a first annular groove 424A and a second annular groove 424B, similar to the first annular groove 224A and the second annular groove 224B of the bearing housing 204 of FIGS. 6 to 9, respectively.

In the illustrated embodiment of FIG. 18, the bearing housing 404 further includes a third annular groove 424C disposed axially between the first annular groove 424A and the second annular groove 424B. FIG. 19 is a partial, cross-sectional view of the bearing housing 404 included in the bearing damper assembly 200 of FIGS. 2 to 15. As shown in FIG. 19, the bearing housing 404 can include a sealing member 470 disposed in the third annular groove 424C. The sealing member 470 may provide increased sealing performance between the first fluid circuit (i.e., the first annular groove 424A) and the second fluid circuit (i.e., the second annular groove 424B) of the bearing damper assembly 200.

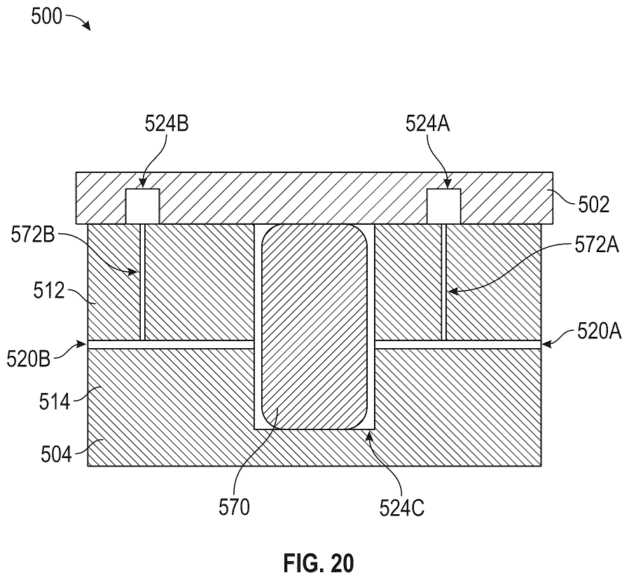

FIG. 20 is a partial, cross-sectional view of another exemplary bearing damper assembly 500, according to another embodiment of the present disclosure. The bearing damper assembly 500 is substantially similar to the bearing damper assembly 200 of FIGS. 2 to 15. The same reference numerals or similar reference numerals will be used for components of the bearing damper assembly 500 that are the same as, or similar to, the components of the bearing damper assembly 200 discussed above with regard to FIGS. 2 to 15. The description of such components above of the bearing damper assembly 200 also applies to these components of the bearing damper assembly 500, and a detailed description of these components is omitted here.

As shown in FIG. 20, the bearing damper assembly 500 includes a damper frame 502 and a bearing housing 504, similar to the damper frame 202 and the bearing housing 204 of the bearing damper assembly 200 of FIGS. 2 to 15. In the illustrated embodiment of FIG. 20, a first annular groove 524A and a second annular groove 524B are defined in the bearing housing 504, and a third annular groove 524C is defined in both an outer rim 512 and an inner rim 514 of the bearing housing 504. A sealing member 570 is disposed in the third annular groove 524C.

The bearing housing 504 further defines a first plurality of gap channels 572A extending from the first annular groove 524A to a first plurality of annular gaps 520A and a second plurality of gap channels 572B extending from the second annular groove 524B to a second plurality of annular gaps 520B. In this way, fluid provided to the first annular groove 524A flows to the first plurality of annular gaps 520A via the first plurality of gap channels 572A. Likewise, fluid provided to the second annular groove 524B flows to the second plurality of annular gaps 520B via the second plurality of gap channels 572B.

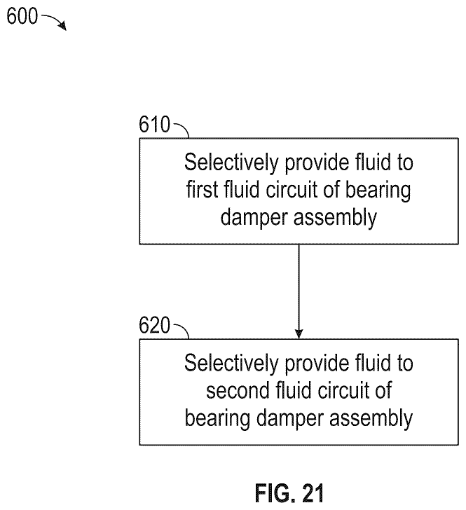

FIG. 21 is a flowchart showing a method 600 of damping vibrations of a rotating component of a turbine engine via a bearing damper assembly. While reference is made to the bearing damping assembly of FIGS. 2 to 17, the method 600 can be utilized with any one of the bearing damping assemblies 200 and 500 of FIGS. 2 to 20.

In step 610, the method 600 includes selectively providing fluid to a first fluid circuit of a bearing damper assembly. For example, with reference to the bearing damper assembly 200 illustrated in FIGS. 2 to 17, step 610 includes providing fluid, via the pump 260 (FIGS. 16A to 16C) to the first fluid circuit (i.e., to the first inlet port 242A and to the first plurality of annular gaps 220A via the first annular groove 224A and the first plurality of gap inlets 228A) of the bearing damper assembly 200. In some embodiments, step 610 can include operating the bearing damper assembly 200 in the second damping mode shown in FIG. 16B (e.g., by moving the first valve 262A to the open position and the second valve 262B to the closed position).

In step 620, the method 600 includes selectively providing fluid to a second fluid circuit of a bearing damper assembly. For example, with reference to the bearing damper assembly 200 illustrated in FIGS. 2 to 17, step 620 includes providing fluid, via the pump 260 (FIGS. 16A to 16C) to the second fluid circuit (i.e., to the second inlet port 242B and to the second plurality of annular gaps 220B via the second annular groove 224B and the second plurality of gap inlets 228B) of the bearing damper assembly 200. In some embodiments, step 620 can include operating the bearing damper assembly 200 in the third damping mode shown in FIG. 16C (e.g., by moving the first valve 262A to the closed position and the second valve 262B to the open position).

In some embodiments, step 620 may be performed before step 610. In some embodiments, step 610 and 620 may be performed simultaneously. For example, with reference to the bearing damper assembly 200 illustrated in FIGS. 2 to 17, in some such embodiments, step 610 and step 620 can include operating the bearing damper assembly 200 in the first damping mode shown in FIG. 16A (e.g., by moving the first valve 262A and the second valve 262B to the open positions).

Accordingly, the present disclosure provides for an improved bearing damper assembly for a turbine engine that provides for variable damping modes that can be used for various operating modes of the turbine engine. Particularly, embodiments of the present disclosure can provide a bearing damper assembly with a first plurality of damping sectors and a second plurality of damping sectors that can be activated independent of one another to provide various damping values of the bearing damper assembly. This can provide for increased operational performance and durability of the bearing damper assembly and the turbine engine over a range of operating speeds.

Further aspects of the present disclosure are provided by the subject matter of the following clauses.

A bearing damper assembly for a turbine engine, the bearing damper assembly defining a bearing damper centerline axis, a radial direction extending perpendicular to the bearing damper centerline axis, and a circumferential direction about the bearing damper centerline axis. The bearing damper assembly comprising a damper frame, a bearing housing disposed in the damper frame, and an end seal plate coupled to the bearing housing. The bearing housing being annular and comprising an outer rim coupled to the damper frame, an inner rim coupled to the outer rim via a plurality of integral springs, and a plurality of annular gaps formed between the inner rim and the outer rim, with each annular gap of the plurality of annular gaps being bound in the circumferential direction by two integral springs of the plurality of integral springs. The plurality of annular gaps including a first plurality of annular gaps and a second plurality of annular gaps. The bearing damper assembly further comprising a first fluid circuit in fluid communication with the first plurality of annular gaps, and a second fluid circuit in fluid communication with the second plurality of annular gaps. The first plurality of annular gaps and the second plurality of annular gaps being configured to be filled with fluid via the first fluid circuit and the second fluid circuit, respectively, to damp vibrations produced on a rotating component of the turbine engine.

The bearing damper assembly of the preceding clause, the end seal plate being coupled to the inner rim of the bearing housing.

The bearing damper assembly of any preceding clause, the first plurality of annular gaps and the second plurality of annular gaps being arranged in an alternating manner in the circumferential direction.

The bearing damper assembly of any preceding clause, the first plurality of annular gaps including at least two annular gaps, the second plurality of annular gaps includes at least two annular gaps, and the plurality of integral springs includes at least eight integral springs.

The bearing damper assembly of any preceding clause, the first plurality of annular gaps including at least three annular gaps, the second plurality of annular gaps includes at least three annular gaps, and the plurality of integral springs includes at least twelve integral springs.

The bearing damper assembly of any preceding clause, the bearing housing further comprising a first annular groove and a second annular groove defined along an outer surface of the outer rim, the first annular groove at least partly defining the first fluid circuit and the second annular groove at least partly defining the second fluid circuit.

The bearing damper assembly of any preceding clause, the bearing housing further comprising a third annular groove defined along the outer surface of the outer rim and disposed axially between the first annular groove and the second annular groove.

The bearing damper assembly of any preceding clause, the bearing housing further comprising a sealing member disposed within the third annular groove.

The bearing damper assembly of any preceding clause, the damper frame including a first inlet port in fluid communication with the first fluid circuit and a second inlet port in fluid communication with the second fluid circuit.

The bearing damper assembly of any preceding clause, further comprising a pump in fluid communication with the first inlet port and the second inlet port of the damper frame, the pump being configured to provide fluid to the first fluid circuit and the second fluid circuit.

The bearing damper assembly of any preceding clause, further comprising at least one valve disposed between the pump and the damper frame, the at least one valve being controllable to control a flow of fluid provided to the first inlet port and to the second inlet port.

The bearing damper assembly of any preceding clause, further comprising an electronic controller in electrical communication with the at least one valve, the electronic controller being configured to selectively provide fluid to the first fluid circuit and to the second fluid circuit via control of the at least one valve.

The bearing damper assembly of any preceding clause, the damper frame defining a first plurality of first outlets of the first fluid circuit configured to permit fluid to flow out of the first plurality of annular gaps at an inner side of the bearing housing and a second plurality of first outlets of the second fluid circuit configured to permit fluid to flow out the second plurality of annular gaps at the inner side of the bearing housing.

The bearing damper assembly of any preceding clause, the damper frame including a plurality of frame recesses that define the first plurality of first outlets and the second plurality of first outlets.

The bearing damper assembly of any preceding clause, the end seal plate defining a first plurality of second outlets of the first fluid circuit configured to permit fluid to flow out of the first plurality of annular gaps at an outer side of the bearing housing, opposite the inner side, and a second plurality of second outlets of the second fluid circuit configured to permit fluid to flow out the second plurality of annular gaps at the outer side of the bearing housing.

The bearing damper assembly of any preceding clause, the end seal plate including a first plurality of seal plate recesses that defines the first plurality of second outlets and a second plurality of seal plate recesses that defines the second plurality of second outlets.

The bearing damper assembly of any preceding clause, a depth of the first plurality of seal plate recesses being different from that of the second plurality of seal plate recesses.

The bearing damper assembly of any preceding clause, the bearing housing defining a first plurality of gap channels extending from the first annular groove to the first plurality of annular gaps and a second plurality of gap channels extending from the second annular groove to the second plurality of annular gaps.

The bearing damper assembly of any preceding clause, the bearing housing including a first plurality of circumferential damping sectors corresponding to the first plurality of annular gaps and a second plurality of circumferential damping sectors corresponding to the second plurality of annular gaps, the bearing damper assembly being configured such that the first plurality of circumferential damping sectors and the second plurality of circumferential damping sectors can be activated independent of one another to provide a plurality of damping values.

The bearing damper assembly of any preceding clause, each integral spring of the plurality of integral springs including a spring portion, an active damper portion, and a deflection limiter portion.

The bearing damper assembly of any preceding clause, the spring portion of the plurality of integral springs being compressible in the radial direction, the active damper portion of the plurality of integral springs being connected to the respective one of the plurality of annular gaps, and the deflection limiter portion of the plurality of integral springs being connected to that of an adjacent integral spring of the plurality of integral springs.

The bearing damper assembly of any preceding clause, the first annular groove being in fluid communication with a first plurality of gap inlets that extend into each of the annular gaps of the first plurality of annular gaps and the second annular groove being in fluid communication with a second plurality of gap inlets that extend into each of the annular gaps of the second plurality of annular gaps.

The bearing damper assembly of any preceding clause, the damper frame including a flange portion that receives the bearing housing and a conical portion extending radially outward from the flange portion.

The bearing damper assembly of any preceding clause, the flange portion of the damper frame having a first seal face that extends radially outward relative to the bearing damper centerline axis and a second seal face that extends perpendicular from the first seal face.

The bearing damper assembly of any preceding clause, the first inlet port and the second inlet port extending from the conical portion to the second seal face of the flange portion of the damper frame.

A method of damping vibrations of a rotating component of a turbine engine comprises selectively providing fluid to at least one of a first fluid circuit of a bearing damper assembly, the first fluid circuit being in fluid communication with a first plurality of annular gaps formed between an outer rim and an inner rim of a bearing housing of the bearing damper assembly, or a second fluid circuit of the bearing damper assembly, the second fluid circuit being in fluid communication with a second plurality of annular gaps formed between the outer rim and the inner rim of the bearing housing of the bearing damper assembly. Each annular gap of the first plurality of annular gaps and of the second plurality of annular gaps of the bearing housing being circumferentially bound by two integral springs of a plurality of integral springs of the bearing housing.

The method of the preceding clause, the first fluid circuit providing a first damping level and the second fluid circuit providing a second damping level that is different from the first damping level.

The method of any preceding clause, the first plurality of annular gaps includes at least three annular gaps, the second plurality of annular gaps includes at least three annular gaps, and the plurality of integral springs includes at least twelve integral springs.

A turbine engine includes at least one bearing damper assembly. The at least one bearing damper assembly comprises a damper frame, a bearing housing disposed in the damper frame, and an end seal plate coupled to the bearing housing. The bearing housing being annular and comprising an outer rim coupled to the damper frame, an inner rim coupled to the outer rim via a plurality of integral springs, and a plurality of annular gaps formed between the inner rim and the outer rim, with each annular gap of the plurality of annular gaps being bound in the circumferential direction by two integral springs of the plurality of integral springs. The plurality of annular gaps including a first plurality of annular gaps and a second plurality of annular gaps. The at least one bearing damper assembly further comprising a first fluid circuit in fluid communication with the first plurality of annular gaps, and a second fluid circuit in fluid communication with the second plurality of annular gaps. The first plurality of annular gaps and the second plurality of annular gaps being configured to be filled with fluid via the first fluid circuit and the second fluid circuit, respectively, to damp vibrations produced on a rotating component of the turbine engine.

The turbine engine of the preceding clause, further comprising a pump in fluid communication with the at least one bearing damper assembly, the pump being configured to provide fluid to the first fluid circuit and the second fluid circuit of the at least one bearing damper assembly.

The turbine engine of any preceding clause, further comprising at least one valve disposed between the pump and the at least one bearing damper assembly, the at least one valve being controllable to control a flow of fluid provided to the first fluid circuit and to the second fluid circuit of the at least one bearing damper assembly.

The turbine engine of any preceding clause, further comprising an electronic controller in electrical communication with the at least one valve, the electronic controller being configured to selectively provide fluid to the first fluid circuit and to the second fluid circuit of the at least one bearing damper assembly via control of the at least one valve.

Although the foregoing description is directed to the preferred embodiments, other variations and modifications will be apparent to those skilled in the art and may be made without departing from the disclosure. Moreover, features described in connection with one embodiment may be used in conjunction with other embodiments, even if not explicitly stated above.

1. A bearing damper assembly for a turbine engine, the bearing damper assembly defining a bearing damper centerline axis, a radial direction extending perpendicular to the bearing damper centerline axis, and a circumferential direction about the bearing damper centerline axis, the bearing damper assembly comprising:
a damper frame;
a bearing housing disposed in the damper frame, the bearing housing being annular and comprising:
an outer rim coupled to the damper frame;
an inner rim coupled to the outer rim via a plurality of integral springs;
a plurality of annular gaps formed between the inner rim and the outer rim, each annular gap of the plurality of annular gaps being bound in the circumferential direction by two integral springs of the plurality of integral springs, the plurality of annular gaps including a first plurality of annular gaps and a second plurality of annular gaps arranged in an alternating manner in the circumferential direction;
a first annular groove defined along an outer surface of the outer rim and a first plurality of gap inlets defined within the first annular groove, the first plurality of gap inlets being in fluid communication with a respective annular gap of the first plurality of annular gaps such that the first annular groove and the first plurality of gap inlets at least partly define a first fluid circuit in fluid communication with the first plurality of annular gaps; and
a second annular groove defined along the outer surface of the outer rim and a second plurality of gap inlets defined within the second annular groove, the second annular groove being fluidly isolated from the first annular groove, the second plurality of gap inlets being in fluid communication with a respective annular gap of the second plurality of annular gaps such that the second annular groove and the second plurality of gap inlets at least partly define a second fluid circuit in fluid communication with the second plurality of annular gaps; and
an end seal plate coupled to the bearing housing,
wherein the first plurality of annular gaps and the second plurality of annular gaps are configured to be filled with fluid via the first fluid circuit and the second fluid circuit, respectively, to damp vibrations produced on a rotating component of the turbine engine.

2. The bearing damper assembly of claim 1, wherein the end seal plate is coupled to the inner rim of the bearing housing.

3. (canceled)

4. The bearing damper assembly of claim 1, wherein the first plurality of annular gaps includes at least two annular gaps, the second plurality of annular gaps includes at least two annular gaps, and the plurality of integral springs includes at least eight integral springs.

5. The bearing damper assembly of claim 4, wherein the first plurality of annular gaps includes at least three annular gaps, the second plurality of annular gaps includes at least three annular gaps, and the plurality of integral springs includes at least twelve integral springs.

6.-8. (canceled)

9. The bearing damper assembly of claim 1, wherein the damper frame includes a first inlet port in fluid communication with the first fluid circuit and a second inlet port in fluid communication with the second fluid circuit.

10. The bearing damper assembly of claim 9, further comprising a pump in fluid communication with the first inlet port and the second inlet port of the damper frame, the pump being configured to provide fluid to the first fluid circuit and the second fluid circuit.

11. The bearing damper assembly of claim 10, further comprising at least one valve disposed between the pump and the damper frame, the at least one valve being controllable to control a flow of fluid provided to the first inlet port and to the second inlet port.

12. The bearing damper assembly of claim 11, further comprising an electronic controller in electrical communication with the at least one valve, the electronic controller being configured to selectively provide fluid to the first fluid circuit and to the second fluid circuit via control of the at least one valve.

13. The bearing damper assembly of claim 1, wherein the damper frame defines a first plurality of first outlets of the first fluid circuit configured to permit fluid to flow out of the first plurality of annular gaps at an inner side of the bearing housing and a second plurality of first outlets of the second fluid circuit configured to permit fluid to flow out the second plurality of annular gaps at the inner side of the bearing housing.

14. The bearing damper assembly of claim 13, wherein the damper frame includes a plurality of frame recesses that define the first plurality of first outlets and the second plurality of first outlets.

15. The bearing damper assembly of claim 13, wherein the end seal plate defines a first plurality of second outlets of the first fluid circuit configured to permit fluid to flow out of the first plurality of annular gaps at an outer side of the bearing housing, opposite the inner side, and a second plurality of second outlets of the second fluid circuit configured to permit fluid to flow out the second plurality of annular gaps at the outer side of the bearing housing.

16. The bearing damper assembly of claim 15, wherein the end seal plate includes a first plurality of seal plate recesses that defines the first plurality of second outlets and a second plurality of seal plate recesses that defines the second plurality of second outlets.

17. The bearing damper assembly of claim 16, wherein a depth of the first plurality of seal plate recesses is different from that of the second plurality of seal plate recesses.

18. A method of damping vibrations of a rotating component of a turbine engine, the method comprising:
selectively providing fluid to at least one of:
a first fluid circuit of a bearing damper assembly, the first fluid circuit being in fluid communication with a first plurality of annular gaps formed between an outer rim and an inner rim of a bearing housing of the bearing damper assembly; or
a second fluid circuit of the bearing damper assembly, the second fluid circuit being in fluid communication with a second plurality of annular gaps formed between the outer rim and the inner rim of the bearing housing of the bearing damper assembly,
wherein the first plurality of annular gaps and the second plurality of annular gaps are arranged in an alternating manner in a circumferential direction of the bearing damper assembly.
wherein each annular gap of the first plurality of annular gaps and of the second plurality of annular gaps of the bearing housing is circumferentially bound by two integral springs of a plurality of integral springs of the bearing housing,
wherein the first fluid circuit is at least partly defined by a first annular groove defined along an outer surface of the outer rim and a first plurality of gap inlets defined within the first annular groove, the first plurality of gap inlets being in fluid communication with a respective annular gap of the first plurality of annular gaps, and
wherein the second fluid circuit is at least partly defined by a second annular groove defined along the outer surface of the outer rim and a second plurality of gap inlets defined within the second annular groove, the second annular groove being fluidly isolated from the first annular groove, the second plurality of gap inlets being in fluid communication with a respective annular gap of the second plurality of annular gaps.

19. The method of claim 18, wherein the first fluid circuit provides a first damping level and the second fluid circuit provides a second damping level that is different from the first damping level.

20. The method of claim 18, wherein the first plurality of annular gaps includes at least three annular gaps, the second plurality of annular gaps includes at least three annular gaps, and the plurality of integral springs includes at least twelve integral springs.

21. A bearing damper assembly for a turbine engine, the bearing damper assembly defining a bearing damper centerline axis, a radial direction extending perpendicular to the bearing damper centerline axis, and a circumferential direction about the bearing damper centerline axis, the bearing damper assembly comprising:
a damper frame;
a bearing housing disposed in the damper frame, the bearing housing being annular and comprising:
an outer rim coupled to the damper frame;
an inner rim coupled to the outer rim via a plurality of integral springs;
a plurality of annular gaps formed between the inner rim and the outer rim, each annular gap of the plurality of annular gaps being bound in the circumferential direction by two integral springs of the plurality of integral springs, the plurality of annular gaps including a first plurality of annular gaps and a second plurality of annular gaps;
a first fluid circuit in fluid communication with the first plurality of annular gaps; and
a second fluid circuit in fluid communication with the second plurality of annular gaps; and
an end seal plate coupled to the bearing housing,
wherein the first plurality of annular gaps and the second plurality of annular gaps are configured to be filled with fluid via the first fluid circuit and the second fluid circuit, respectively, to damp vibrations produced on a rotating component of the turbine engine,
wherein the damper frame defines a first plurality of first outlets of the first fluid circuit configured to permit fluid to flow out of the first plurality of annular gaps at an inner side of the bearing housing and a second plurality of first outlets of the second fluid circuit configured to permit fluid to flow out the second plurality of annular gaps at the inner side of the bearing housing, and
wherein the end seal plate defines a first plurality of second outlets of the first fluid circuit configured to permit fluid to flow out of the first plurality of annular gaps at an outer side of the bearing housing, opposite the inner side, and a second plurality of second outlets of the second fluid circuit configured to permit fluid to flow out the second plurality of annular gaps at the outer side of the bearing housing.

22. The bearing damper assembly of claim 21, wherein the end seal plate includes a first plurality of seal plate recesses that defines the first plurality of second outlets and a second plurality of seal plate recesses that defines the second plurality of second outlets.

23. The bearing damper assembly of claim 22, wherein a depth of the first plurality of seal plate recesses is different from that of the second plurality of seal plate recesses.

24. The bearing damper assembly of claim 1, wherein the first plurality of annular gaps corresponds to a first plurality of circumferential damping sectors and the second plurality of annular gaps corresponds to a second plurality of circumferential damping sectors, and wherein the first fluid circuit and the second fluid circuit are independently controllable to selectively activate the first plurality of circumferential damping sectors and the second plurality of circumferential damping sectors.
